(19) United States
(12) Patent Application Publication
(10) Pub. No.: US 2022/0270186 A1
(43) Pub. Date: Aug. 25, 2022

(54) System and Method for Determining the Impact of a Social Media Post across Multiple Social Media Platforms

(71) Applicant: LIFEBRAND LLC, West Chester, PA (US)

(72) Inventors: Sheriff Popoola, West Chester, PA (US); Joseph A. Myshko, West Chester, PA (US); Aaron Kager, West Chester, PA (US); Jemma Barbarise, West Chester, PA (US); Thomas J. Colaiezzi, West Chester, PA (US)

(21) Appl. No.: 17/680,230

(22) Filed: Feb. 24, 2022

Related U.S. Application Data
(60) Provisional application No. 63/152,889, filed on Feb. 24, 2021.
(60) Provisional application No. 63/152,904, filed on Feb. 24, 2021.

(51) Int. Cl. G06Q 50/00; G06F 40/20; G06K 9/62

(52) U.S. Cl. CPC G06Q 50/01; G06F 40/20; G06K 9/6269

(57) ABSTRACT

The disclosed embodiments provide a systems and methods to determine the impact of a social media post across multiple social media platforms. In certain embodiments, data provided to the business is granted by the individual's consent in a timestamped, continuous, revocable permission. In certain embodiments, each user's Social Media posts are sent through an NLP module for analysis of the post. Analysis related to detected profanity is sent to the Profanity labeling function and analysis related to toxicity is sent to the Toxicity labeling function. In parallel, the user's post is also sent to the Reach module which determines the reach of the post on each Social Media platform to which the user disseminated the post. An optional Personal Brand modifier may be used where the user can provide demographic details to further assess the impact of the post on the individual's personal brand. The Impact function receives inputs from each of the modules and delivers a score indicative of the impact of that social media post.

### CROSS-REFERENCE TO RELATED APPLICATIONS

This application claims the benefit of U.S. Prov. App. Nos. 63/152,889 and 63/152,904, each of which is hereby incorporated in its entirety by reference.

### FIELD OF THE INVENTION

The present invention relates to methods, apparatus, and systems, including computer programs encoded on a computer storage medium, for Artificial/Machine Learning analysis of social media posts.

### BACKGROUND OF THE INVENTION

Artificial intelligence (AI) is the name of a field of research and techniques in which the goal is to create intelligent systems. Machine learning (ML) is an approach to achieve this goal. Deep learning (DL) is the set of latest most advanced techniques in ML.

The execution of machine learning models and artificial intelligence applications can be very resource intensive as large amounts of processing and storage resources can be consumed. The execution of such models and applications can be resource intensive, in part, because of the large amount of data that is fed into such machine learning models and artificial intelligence applications.

Current tools used in social media involve word-matching, which looks for the occurrence of the query words in social media posts. This type of search is not efficient because the presence or absence of words of the query compared to the quantity of social media does not necessarily confirm the relevance or irrelevance of the found documents. For example, a word search might find documents that contain words but that are contextually irrelevant. Or, if the user applied a different terminology for the query that is contextually or even texturally different than the one in the documents, the word-matching process would fail to match and locate relevant text.

Current word and image analysis are limited in their capabilities. For example, with word-matching research tools, it is crucial to create a word limit in the query presented to the system. Furthermore, all of the words should be in without extraneous detail. However, if the input includes too many generic words, the research tool will return irrelevant social media posts that contain these generic words. This task of choosing very few, but informative words, is challenging, and the user needs prior knowledge of the field to complete the task. The user should know what information is significant or insignificant and therefore, should or should not be included in the search (i.e., contextualization), and further, the proper/accepted terminology that is best for expressing the information (i.e., lexicographical textualization). If the user fails to include the important or correct terms or includes too many irrelevant details, the searching system will not operate successfully.

Even improved analytic tools face the same challenge that word-matching research tools suffer, specifically overfilling, which is a technical term in data science related to when the observer reads too much into limited observations. The improved tools consider and search each record one at a time, independent from the rest of the records, trying to determine whether the social media contains the query or not, without paying attention to the entirety of the relevant social media posts and how they apply in different situations. This challenge of modern research tools manifests itself within the produced results.

For other tools, instead of receiving a query, a document is received from the user. Such tools process the uploaded document to extract the main subjects, and then perform a search for these subjects and returns the results. These tools can be treated as a two-step analytical engine: in the first step, the research tool extracts the main subjects of a document with methods such as word frequency, etc.; and in the second step, the research tool performs a regular search for these subjects over the world of associated social media posts. Such research tools suffer from the same problem of overfitting, sensitivity to the details, and lack of a universal measure for assessing relevance in relation to a user's query.

The results of such research tools are sensitive to the query. That is, tweaking the query in a small direction causes the results to change dramatically. The altered query may exist in a different set of case files, and therefore the results are going to be confusingly different. Moreover, since the focus of these research tools is on one document at a time, the struggle is really to combine and sort the results in terms of relevance to the query. Sorting the results is done based on how many common words exist between the query and the case file, or how similar the language of the query is to that of a case. As a result, the results run the risk of being too dependent on the details of the query and the case file, rather than concentrating on the importance of a case and its conceptual relevance to the query.

Power consumption and carbon footprints are other considerations in research systems, and thus should also be addressed. Analytic systems such as the present invention process big data. For example, when a user enters a query to a system, the system takes the query, and searches data that can be composed of tens of millions of files and websites (if not more), to find matches. This single search by itself requires a lot of resources in terms of memory to store the files, compute power to perform the search on a document, and communication to transfer the documents from a hard disk or a memory to the processor for processing. Even for a single search, a regular desktop computer may not perform the task in a timely manner, and therefore a high-performance server is required. Techniques such as database indexing make searching a database faster and more efficient; however, the process of indexing and retrieving information remain a complex, laborious and time-consuming process. As a result, a legal research tool needs a large data center to operate. Such data centers are expensive to purchase, setup, and maintain; they consume a lot of electricity to operate and to cool down; and they have large carbon footprint. It is estimated that data centers consume about 2% of electricity worldwide and that number could rise to 8% by 2030, and much of that electricity is produced from non-renewable sources, contributing to carbon emissions. A research tool can be hosted on a local data center owned by the provider of the research tool, or it can be hosted on the cloud. Either way, the equipment cost, operation cost, and electricity bill will be paid by the provider of the service one way or another. A more efficient social media analysis tool that only needs a small amount of resources, consumes less electricity per query, and has a smaller carbon footprint compared to existing tools such as those discussed above.

Moreover, the impact of a social media post by a user today is currently very subjective without any existing regulation and/or guidance. Prior to this invention, impact has been attempted on a ‘platform-by-platform’ basis. Any cross-platform impact has been done is a subjective fashion, manually.

In fact, most prior art systems are manual and subjective to the reviewer. Those the prior art systems that implement artificial intelligence/machine learning do not analyze as efficiently for each social media post for how impactful the post is within the social media platform based on how many other users view the post and interact with the post. Prior art systems also do not analyze the post across multiple social media platforms to determine the cross-platform reach of the post. Prior art systems do not factor in the personal profile of the account owner (user).

### BRIEF SUMMARY OF THE INVENTION

It is therefore an object of the invention to disclose systems and methods for determining the impact of a Social Media post across multiple social media platforms. The systems and methods are comprised of a Natural Language Processing (NLP) function, a Reach function, a Profanity labeling function, a Toxicity labeling function, a Personal Brand modifier, and an Impact.

In certain embodiments, the NLP function receives a post via a user-initiated scan action, analyzes the post for text, image, and video and sends the output of that analysis to the appropriate labeling function and to the impact function, as applicable. In tandem, the Reach function receives the same post received by the NLP function and analyzes the post for reach across all social media platforms to which the user disseminated that post and sends the result of that analysis to the Impact function. Based on the account owner's (user's) profile the Personal Brand modifier function will send its output to the Impact function. The Impact function (M006) will then output a score which is an objective indicator of how impactful a specific post is to the user.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram of an exemplary embodiment of the hardware of the system of the present invention;

FIG. 2 is a diagram of an exemplary artificial intelligence algorithm as incorporated into the hardware of the system of the present invention;

FIG. 3 is a diagram showing the user consent flow in accordance with an exemplary embodiment of the invention;

FIG. 4 is a diagram of the analysis scanning (data collection) analysis and reporting/notification flow of the system of the present invention;

FIG. 5 is a diagram of a continuous flow scan in accordance with an exemplary embodiment of the invention;

FIG. 6 is a diagram of an interface for revoking user access and consent revocation subsystem flow in accordance with an exemplary embodiment of the invention; and

FIG. 7 is an exemplary diagram of the various software components of the present invention.

### DETAILED DESCRIPTION OF THE INVENTION

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose. Several preferred embodiments of the invention are described for illustrative purposes, it being understood that the invention may be embodied in other forms not specifically shown in the drawings.

Since social media posts are created by individuals on individual social media platforms, posts need to be scanned to determine if they are possibly harmful or not. Post data across multiple platforms is collected and analyzed to determine if a post could be harmful to the client. So, the invention integrates with the social media platforms and pulls posts from the client's timelines, analyzes the posts and notifies the client of possible harmful posts.

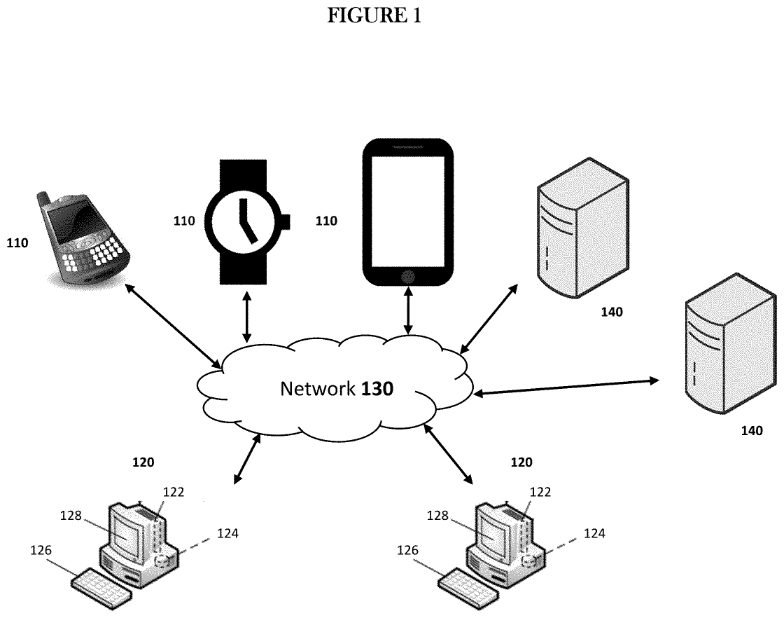

FIG. 1 is an exemplary embodiment of the social media analysis system of the present invention. In the exemplary system 100, one or more peripheral devices 110 are connected to one or more computers 120 through a network 130. Examples of peripheral devices/locations 110 include smartphones, tablets, wearables devices, and any other electronic devices that collect and transmit data over a network that are known in the art. The network 130 may be a wide-area network, like the Internet, or a local area network, like an intranet. Because of the network 130, the physical location of the peripheral devices 110 and the computers 120 has no effect on the functionality of the hardware and software of the invention. Both implementations are described herein, and unless specified, it is contemplated that the peripheral devices 110 and the computers 120 may be in the same or in different physical locations. Communication between the hardware of the system may be accomplished in numerous known ways, for example using network connectivity components such as a modem or Ethernet adapter. The peripheral devices/locations 110 and the computers 120 will both include or be attached to communication equipment. Communications are contemplated as occurring through industry-standard protocols such as HTTP or HTTPS.

Each computer 120 is comprised of a central processing unit 122, a storage medium 124, a user-input device 126, and a display 128. Examples of computers that may be used are: commercially available personal computers, open source computing devices (e.g. Raspberry Pi), commercially available servers, and commercially available portable device (e.g. smartphones, smartwatches, tablets). In one embodiment, each of the peripheral devices 110 and each of the computers 120 of the system may have software related to the system installed on it. In such an embodiment, system data may be stored locally on the networked computers 120 or alternately, on one or more remote servers 140 that are accessible to any of the peripheral devices 110 or the networked computers 120 through a network 130. In alternate embodiments, the software runs as an application on the peripheral devices 110, and include web-based software and iOS-based and Android-based mobile applications.

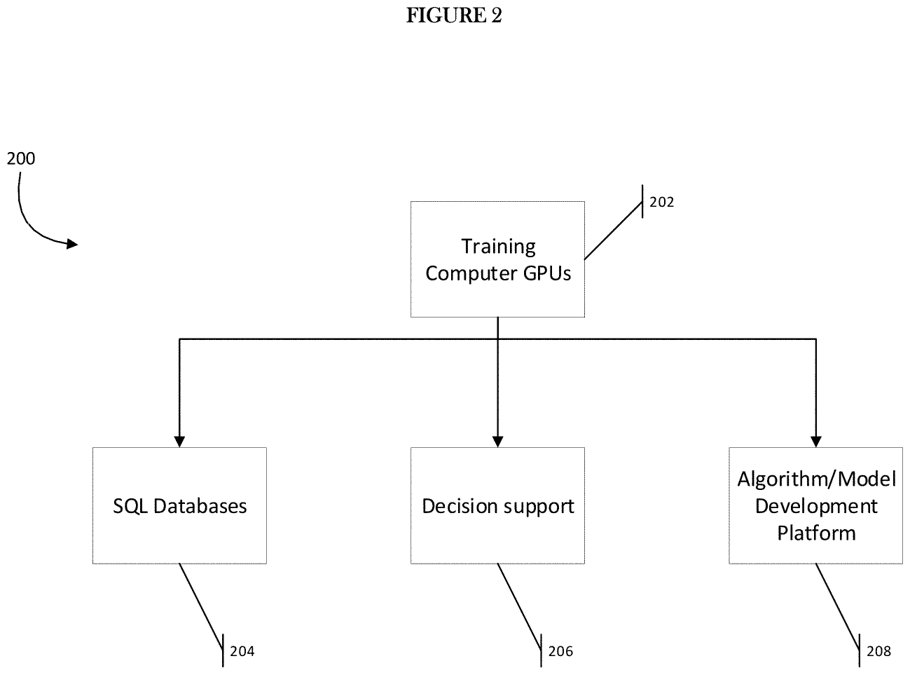

FIG. 2 describes an exemplary artificial intelligence algorithm as incorporated into the hardware of the system of the present invention. To enable the system to operate, a separate training and testing computer or computers 202 with appropriate and sufficient processing units/cores, such as graphical processing units (GPU), are used in conjunction with a database of knowledge, exemplarily an SQL database 204 (for example, comprising terms of interest in social media and their associated semantic/linguistic meanings and effect on a person's reputation), a decision support matrix 206 (for example, cross-referencing possible algorithmic decisions, system states, and third-party guidelines), and an algorithm (model) development module 208 (for example, a platform of available machine learning algorithms for testing with data sets to identify which produces a model with accurate decisions for a particular instrument, device, or subsystem). The learning algorithms of the present invention use a known dataset to thereafter make predictions. The dataset training includes input data that produces response values. The learning algorithms are then used to build predictive models for new responses to new data. The larger the training datasets, the better will be the prediction models. The algorithms contemplated include support vector machines (SVM), neural networks, Naïve Bayes classifier and decision trees. The learning algorithms of the present invention may also incorporate regression algorithms include linear regression, nonlinear regression, generalized linear models, decision trees, and neural networks. The invention comprises of different model architectures such as convolutional neural networks, tuned for specific content types such as image, text and emojis, and video, as well as text-in-image, text-in-video, audio transcription and relational context of multimedia posts.

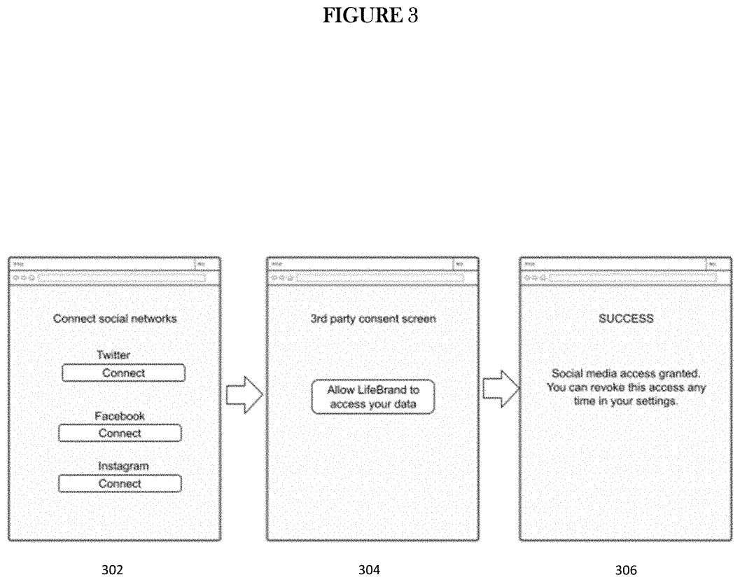

FIG. 3 is a diagram showing the user consent flow in accordance with an exemplary embodiment of the invention. FIG. 3 therefore describes an exemplary protocol for the system of the present invention to obtain authorization from a user prior to performing any analysis of the user's social media. Before any data is collected or analyzed, the user is asked to consent to data collection. Without user consent, no data is stored, nor analyzed. At a first screen 302, a user is prompted to connect his or her social networks to the social media analysis system. The user can connect such social media as Twitter, Facebook, and Instagram to the system. Other social media networks known in the art are also contemplated as being within the scope. Upon approving the connection to a social media network, the user is taken to a third-party consent screen 304. At this screen, the user is asked to verify and affirmatively grant access to his or her social media data to the system of the present invention. Upon granting access to that social media network and its data, the user is returned to a success screen 306, where the system notifies the user that access to his or her social media data has been granted.

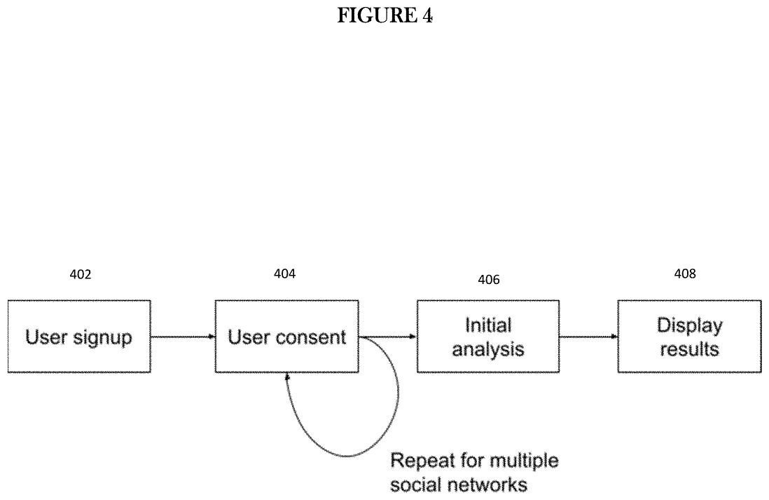

FIG. 4 is a diagram of the analysis scanning (data collection) analysis and reporting/notification flow of the system of the present invention. The process commences at User signup 402, where the user is prompted to sign up for the services provided by the system of the present invention. The system next attempts to obtain user consent 404 for data, as explained with regard to FIG. 3 above. User consent 404 is obtained for one or more social networks, and the steps of FIG. 3 are repeated as necessary for multiple social networks. Once the user's data is collected by the system, an initial analysis is performed to identify unfavorable social media posts or other objectionable data. Unfavorable and objectionable data is identified using a machine learning algorithm, as exemplarily described with respect to FIG. 2 above. Once the user's social media has been analyzed for unfavorable or objectionable data, the results of the analysis are displayed 408.

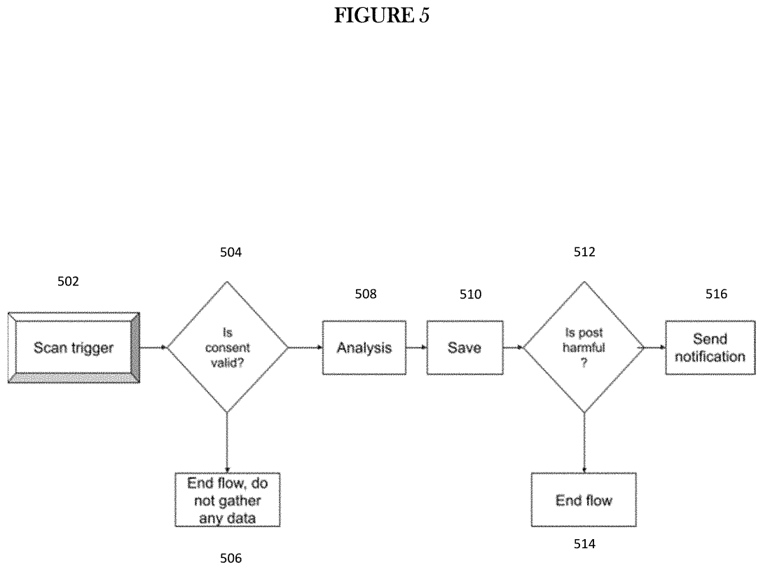

FIG. 5 is a diagram of a continuous flow scan in accordance with an exemplary embodiment of the invention. In certain cases, the system may also perform a continuous scan of the user's social media. The process commences at the scan trigger 502, which can be any predetermined reason to begin a scan of the user's social media. A continuous scan can be triggered by time, detection of an individual post, or change in the analysis algorithm. Regardless of the origin of the scan, the validity of the consent is always checked 504. If consent is determined to not have been granted by the user, the process ends 506, and the system does not collect or analyze any data for the user. If the user has granted the system access to his or her social media data, then the system performs an analysis of the user's social media 508, applying the machine learning algorithms described with regard to FIG. 2 to identify unfavorable or objectionable data. Words, phrases, images, videos, text and audio from image and video are all taken from user social media to perform the analysis. The determinations of the algorithm are saved to the user's profile 510. Those determinations include whether the user post is potentially harmful, and also what category of harmful post it falls under. The system then determines based on the analysis, whether the social media post is harmful 512. If the system determines that there are no harmful posts presents, the system process ends 514. However, if the system determines that there is a harmful post present, it notifies the user 516 so that the user may remove it.

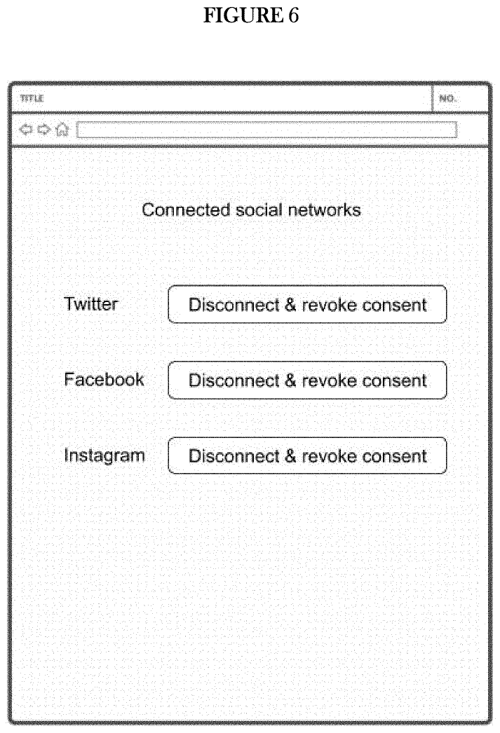

FIG. 6 is a diagram of an interface for revoking user access and consent revocation subsystem flow in accordance with an exemplary embodiment of the invention. Users are presented with an option to revoke granted permissions to individual third-party social networks. The networks include Twitter, Facebook, Instagram, as well as any other social networks known in the art. Other social media platforms can be added as it makes sense to do so. After revoking permission, all the data connected to the user is anonymized and the data is no longer used to analyze users' data.

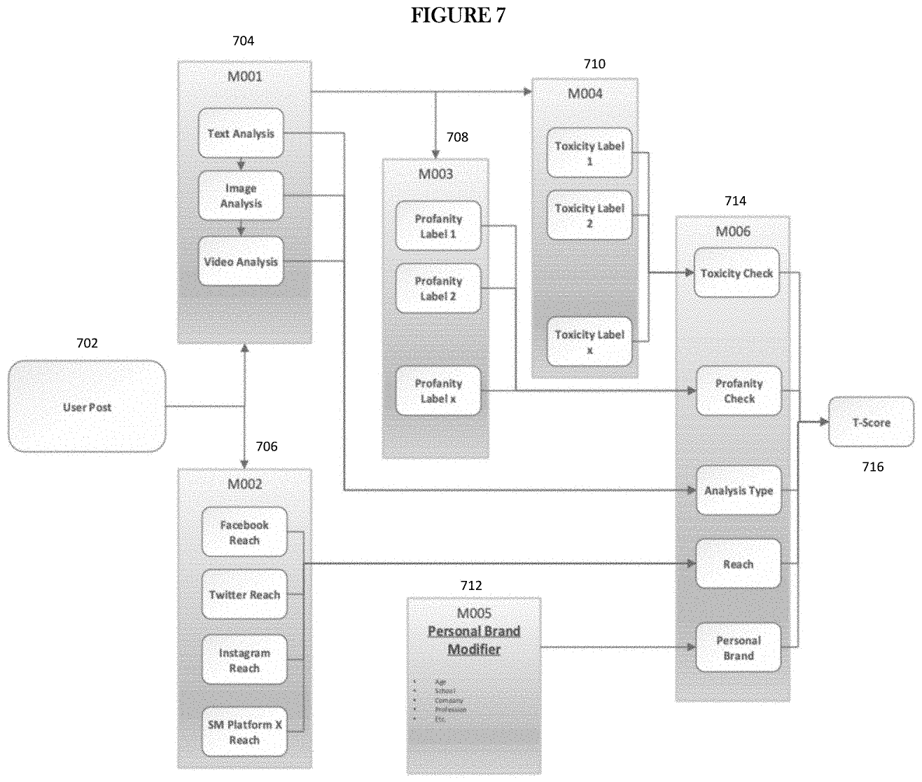

FIG. 7 is an exemplary diagram of the various software components of the present invention. The software architecture of the present invention is preferably comprised of: an NLP Function (M001) 704, Reach Function (M002) 706, Profanity Labeling Function (M003) 708, Toxicity Labeling Function (M004) 710, Personal Brand Modifier Function (M005) 712, and the Impact Function (M006) 714.

In general, the software processes of the present invention commence at the user post 702. In certain embodiments, the NLP function (M001) 704 receives a post 702 via an automatic or user-initiated scan action. The NLP function (M001) 704 is comprised of a text analysis module, image analysis module, and video analysis module. The NLP function (M001) 704 analyzes the post for text, image, and video using the machine learning algorithm described above and sends the output of that analysis to the appropriate labeling function, which is either Profanity Labeling Function (M003) 708, Toxicity Labeling Function (M004) 710, and to the Impact Function (M006) 714, as applicable. The criteria for transmitting the output to one or more of the functions is determined by the content type, and the algorithm will then determine if harmful words, phrases, image objects, gestures, and overall context are potentially harmful or not.

The analysis is performed by passing the content type to the appropriately tuned model (i.e. a CNN designed and trained against images and labels). The analysis is looking for socially harmful or brand damaging content. The obtained content type can be identified by reading simple file extensions (ex. a string or .txt file for text, a .png or .jpeg file for image, a .mp4 or .mov file for video) as well as reading the headers of image and video. For instances of video, a helper function extracts audio and then transcribes speech that it recognizes into text. The software can also assess movements and gestures in video as well as obscenities in images.

The toxicity and profanity measure of the post is determined using machine learning algorithms that are trained to determine toxic and profane content that is stored at a knowledge base such as an SQL database. Exemplarily, the software uses output classes at a Softmax layer, where the output classes of a dense layer are a binary representation of whether the input vector contains one of any number of topics, such as racially sensitive, politically sensitive, etc. The problem is fundamentally a multi-label classification problem, so an input vector can result in zero to as many labels as properly defined and trained on. The model is trained on a knowledge base of input instances (such as text, image, video) and properly labeled outputs.

In tandem, the Reach Function (M002) 706 receives the same post received by the NLP function (M001) 704 and analyzes the post for reach across all social media platforms to which the user disseminated that post. The reach of the post is determined as a function of the number of views and interactions with the post. The Reach Function (M002) 706 sends the result of that analysis to the Impact Function (M006) 714. The mathematical representation of Reach Function (M002) 706 begins with seed weights for each analysis type such as image, text, and video (found in the T-Score equation). The software similar utilizes seed weights for the Profanity Check, with types such as identity attacks, insults, obscenities, threats, toxicity, severe toxicity, sexual content, inappropriate content, blasphemy, and discriminatory content. The weights for “Analysis Type” are optimized through a function such as gradient descent based on intermediate staged outputs of the Reach function defined in Reach Function (M002) 706. The Reach Function (M002) 706 can also look at whether someone cuts or pastes a post to another platform and people view/interact with it there. For example, for a Facebook post, the software may analyze and sum such factors as the reactions to the post, the comments, and/or the shares. For an exemplary Twitter post, the software may analyze and sum such factors as the retweet count, the like count, the reply count, and/or the quote count. In a situation where the software is analyzing content from Facebook and Twitter, the Reach will be the sum of the Facebook Reach and the Twitter Reach. An exemplarily method of determining Reach is outlined by the equations below:

$$Profanity Check = label\_ 1 * 10 * Confidence + label\_ 2 * 10 * Confidence + label\_ 3 * 10 * Confidence + … \\ Toxicity Check = label\_a * 10 * Confidence + label\_b * 10 * Confidence + label\_c * 10 * Confidence + … \\ Reach = FB Reach + Twitter Reach \\ FB Reach = reactions + comments + shares \\ Twitter Reach = retweet count + like count + reply count + quote count \\ T - Score = Analysis Type * ( Profanity Check + Toxicity Check ) * Reach$$

Based on the account owner's (user's) profile, which includes a predetermined set of parameters that outline the user's tolerance to potentially objectionable content, the Personal Brand Modifier Function (M005) 712 will send its output to the Impact Function (M006) 714. The characteristics of the individual such as their demographic, their age, sex, profession, etc. are all taken into consideration and fed into a neural network which will define a classification output for the type of user persona.

The Personal Brand Modifier Function (M005) 712 calculates how removal of a particular post will affect the user's online reputation. The personal brand is comprised of parameters that create a profile of preferences associated with the user, more specifically, how the user would like to be portrayed and his or her tolerances to contentious social media content. The user can also provide demographic details to further assess the impact of the post on the individual's personal brand. The Impact function takes inputs from Toxicity Check, Profanity Check, Analysis type, Reach, and Personal brand modification (demographic details, tolerances to social input of all sorts). An exemplary T-Score equation is provided below:

$$T - Score = Analysis Type * ( Profanity Check + Toxicity Check ) * Reach$$

The Impact Function (M006) 714 will then output a score 716, which is an objective indicator of how impactful a specific post is to the user. The score 716 is calculated as a function of a toxicity check, a profanity check, the analysis type, the reach score, and the personal brand. These factors are given a seeded weight and are optimized through a function such as gradient descent based on the intermediate staged outputs of the Reach function. These results are compared to the results of other users with similar Personal Brand characteristics. That score 716 can then be output to the user.

It should be noted that the foregoing process may be performed on an ongoing basis and repeated as necessary, to provide the user with a current, updated score of his or her social media activity.

The foregoing description and drawings should be considered as illustrative only of the principles of the invention. The invention is not intended to be limited by the preferred embodiment and may be implemented in a variety of ways that will be clear to one of ordinary skill in the art. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A computer-implemented method comprising:
receiving data associated with a user's social media;
analyzing the social media using a machine learning algorithm, the social media data of the user to identify harmful content;
calculating a score representing a reach of the social media across one or more social media networks;
calculating score representing an impact of the social media, wherein the impact score is calculated as a function of a toxicity check, a profanity check, an analysis type, the reach score, and personal brand parameters; and
outputting the impact score to the user through a graphical user interface.

2. The method of claim 1, wherein the social media comprises the user's posts.

3. The method of claim 1, wherein the impact score is an objective indicator of how impactful the social media is to the user.

4. The method of claim 1, wherein the reach score is calculated as a function of the number of views and interactions with the social media.

5. The method of claim 1, further comprising analyzing the social media for toxicity.

6. The method of claim 1, further comprising analyzing the social media for profanity.

7. The method of claim 1, wherein the personal brand parameters are comprised of a profile of preferences associated with the user.

8. The method of claim 1, wherein the machine learning algorithm is comprised of support vector machines (SVM), neural networks, Naïve Bayes classifier, and decision trees

9. The method of claim 1, further comprising storing the harmful posts to a user profile.

10. The method of claim 1, further comprising verifying the user's permission to collect data from the social media.

11. A computer-readable storage medium having computer-executable instructions stored thereupon which, when executed by one or more processors of a computing device, cause the one or more processors of the computing device to:
receive data associated with a user's social media;
analyze the social media using a machine learning algorithm, the social media data of the user to identify harmful content;
calculate a score representing a reach of the social media across one or more social media networks;
calculate score representing an impact of the social media, wherein the impact score is calculated as a function of a toxicity check, a profanity check, an analysis type, the reach score, and personal brand parameters; and
output the impact score to the user through a graphical user interface.

12. The computer-readable storage medium of claim 1, wherein the social media comprises the user's posts.

13. The computer-readable storage medium of claim 1, wherein the impact score is an objective indicator of how impactful the social media is to the user.

14. The computer-readable storage medium of claim 1, wherein the reach score is calculated as a function of the number of views and interactions with the social media.

15. The computer-readable storage medium of claim 1, wherein the one or more processors analyze the social media for toxicity.

16. The computer-readable storage medium of claim 1, wherein the one or more processors analyze the social media for profanity.

17. The computer-readable storage medium of claim 1, wherein the personal brand parameters are comprised of a profile of preferences associated with the user.

18. The computer-readable storage medium of claim 1, wherein the machine learning algorithm is comprised of support vector machines (SVM), neural networks, Naïve Bayes classifier, and decision trees

19. The computer-readable storage medium of claim 1, wherein the one or more processors store the harmful posts to a user profile.

20. The computer-readable storage medium of claim 1, wherein the one or more processors verify the user's permission to collect data from the social media.
